(19) United States
(12) Patent Application Publication
(10) Pub. No.: US 2025/0348277 A1
(43) Pub. Date: Nov. 13, 2025

(54) USING REDUCED READ ENERGY BASED ON THE PARTIAL-SUM

(71) Applicant: Taiwan Semiconductor Manufacturing Co., Ltd., Hsinchu (TW)

(72) Inventors: Win-San Khwa, Taipei (TW); Ping-Chun Wu, Hsinchu (TW); Yi-Lun Lu, New Taipei (TW); Jui-Jen Wu, Hsinchu (TW); Meng-Fan Chang, Taichung (TW)

(21) Appl. No.: 19/277,560

(22) Filed: Jul. 23, 2025

Related U.S. Application Data
(63) Continuation of application No. 17/860,228, filed on Jul. 8, 2022.
(60) Provisional application No. 63/268,830, filed on Mar. 3, 2022.
(60) Provisional application No. 63/269,899, filed on Mar. 25, 2022.

(51) Int. Cl. G06F 7/50

(52) U.S. Cl. CPC G06F 7/50

(57) ABSTRACT

Embodiments include monitoring a partial sum of a multiply accumulate calculation for certain conditions. When the certain conditions are met, a reduced read energy is used to read out memory contents instead of the regular read energy used. The reduced read energy may be obtained by reducing a pre-charge voltage, withholding a pre-charge voltage or providing a ground signal, and/or by reducing voltage hold times (i.e., reducing the time a pre-charge voltage is provided and/or discharged).

### PRIORITY CLAIM AND CROSS-REFERENCE

This application is a continuation of U.S. patent application Ser. No. 17/860,228, filed on Jul. 8, 2022, which claims the benefit of U.S. Provisional Application No. 63/269,899, filed on Mar. 25, 2022, which application is hereby incorporated herein by reference. This application also claims the benefit of U.S. Provisional Application No. 63/268,830, filed on Mar. 3, 2022, which application is hereby incorporated herein by reference.

### BACKGROUND

Multiply accumulators may be used to multiply input data by respective weighting data in a word-wise bit-wise manner. Input data is read from memory, multiplied by weights, and the result stored in a multiply accumulate register. The result may be used in various applications, such as use in an artificial intelligence calculation.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1 and 2 illustrate an input node, weighting vectors and summation which may be used in accordance with some embodiments.

FIGS. 3-6 illustrate various stages of a multiply accumulate computation (MAC), in accordance with some embodiments.

FIG. 7 illustrates a compute-in-memory (CIM) system diagram for providing a MAC operation, in accordance with some embodiments.

FIG. 8 illustrates a high-level block diagram 100 for a dynamic read operation, in accordance with some embodiments.

FIG. 9 illustrates an example implementation of the MAC block 160.

FIG. 10 illustrates a flow diagram providing a process flow 200 for performing a MAC operation, in accordance with some embodiments.

FIGS. 11 and 12 illustrate a flow diagram providing process flow 240 for evaluating if the PS meets a dynamic read condition, in accordance with some embodiments.

FIG. 13 illustrates an example implementation of the DYNR block for evaluating and determining whether the RRE signal is asserted or not, in accordance with some embodiments.

FIG. 14 illustrates an example set of logic conditions which may be enabled rather than a one-for-one input of the select bits of the partial sum PS, in accordance with some embodiments.

FIGS. 15 through 22 illustrate a sample calculation and demonstration of the operation of the DYNR block, in accordance with some embodiments.

FIG. 23 provides a chart demonstrating the reduced read energy which may be obtained when the reduced read energy is enabled, in accordance with some embodiments.

FIG. 24 illustrates the relationship between read voltage and the sensing yield, in accordance with some embodiments.

FIG. 25 illustrates a simplified schematic illustrating the read path of one IO associated with an array, in accordance with some embodiments.

FIG. 26 illustrates an expanded view of FIG. 25, in accordance with some embodiments.

FIG. 27 illustrates a view of a timing diagram and sense amplifier, in accordance with some embodiments.

FIG. 28 illustrates a view of a logic circuit diagram which provides no precharging if the reduced read energy is enabled.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. It should be appreciated that signals may be asserted high 1 or low 0, and that ‘1’ as used herein is understood to mean ‘asserted’ unless otherwise stated by context or convention, and that ‘0’ as used herein is understood to mean ‘unasserted’ unless otherwise stated by context or convention. One of skill in the art can readily invert these signals as needed depending on the devices and designs.

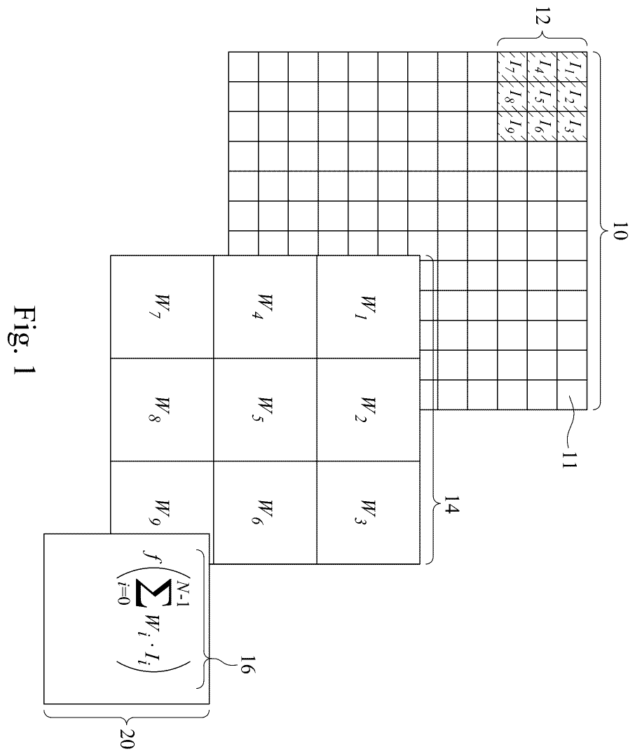

In the area of artificial neural networks, machine learning takes input data, performs some calculation on the input data, and then applies an activation function to process the data. The output of the activation function is essentially some simplified representation of the input data. The input data can be a node of data in a layer of nodes. FIG. 1 illustrates an example of a 3×3 convolution which may be used in processing image data in machine learning. An image 10 is made of individual pixels 11. Images can be represented in a color space, such as RGB (red-green-blue) or HSL (hue-saturation-luminescence), with one value for each of the color-space variables being assigned for each pixel. A node 12 of the image is a 3×3 block of pixels, with each pixel 11 in the node 12 having an input value 11.9 for each of the color-space variables of the pixels 11 of the node 12. One possible computation in a 3×3 convolution uses a product-sum calculation, where each input value I₁₋₉ is respectively multiplied by weighting values W₁₋₉ of a weighting matrix 14. As each multiplication is made, a running sum total can be kept of each of the products. Such a product-sum calculation may be referred to as a multiply accumulate computation/calculation (MAC) 16. During the computational process, the intermediate value may be referred to as the Accumulated Product Sum (APS). At the end of the computational process, the APS is taken as the output of the MAC 16. This output can then be provided to an activation function for evaluation.

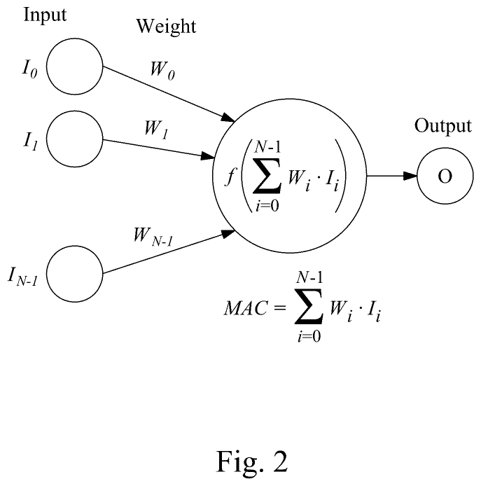

FIG. 2 illustrates the concept illustrated in FIG. 1 in a more general manner, i.e., for any length N input node. Each of the inputs I₀-I_{N-1} is respectively multiplied by a weighting vector W₀-W_{N-1}. Then these values are summed in a product-sum calculation (the MAC). The MAC may then be taken as output O and optionally provided to an activation function or used in some other way.

One could write a computer program to be executed on a general purpose processor including, for example, a for-loop that performs a MAC on an INPUT array and a WEIGHT array, such as in the following pseudocode:

Initialize a counter integer to 0.
Initialize a storing variable (e.g., APS) to 0.
Provide an INPUT array having the length n with input values.
Provide a WEIGHT array having the length n with signed weight values.
For counter = 0, counter < n, counter++ {
APS = APS + (INPUT[counter] * WEIGHT[counter]).
}
MAC =APS.
Provide MAC as output.

To improve efficiency, this algorithm may be implemented in dedicated hardware, for example, in an application specific integrated circuit (ASIC) or field programmable gate array (FPGA). Implementing this logic in dedicated hardware, such as an application specific integrated circuit (ASIC), however, involves the use of binary math in digital logic blocks. Such hardware implementations may be referred to as a compute-in-memory (CIM) implementation. The CIM implementation involves reading out data from memory storage, including input data and weight data and performing simple operations on them, including the MAC operation. The CIM implementation in hardware as described herein uses binary math to compute the MAC.

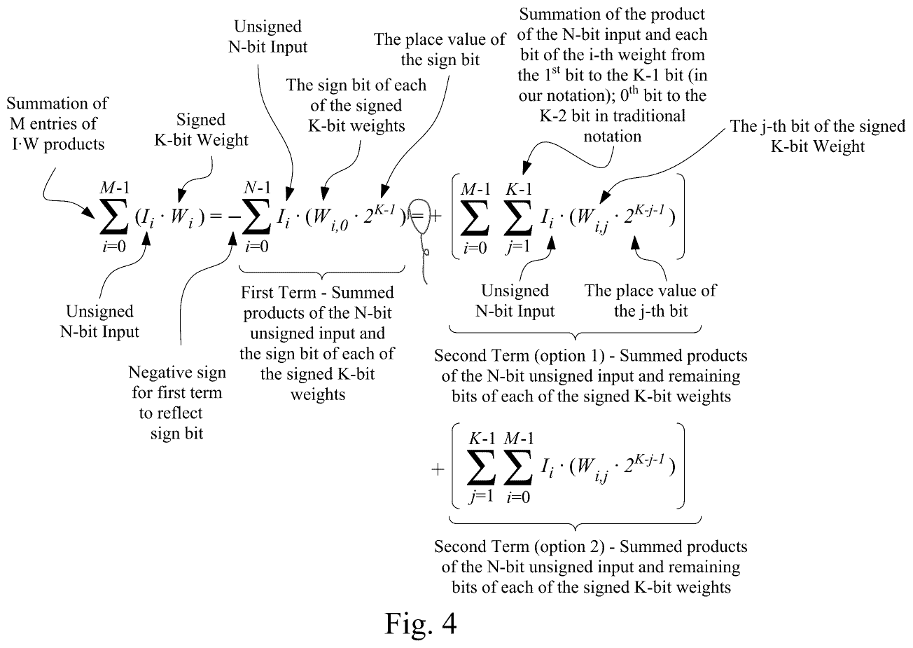

FIG. 4 illustrates a binary representation of the input data, the weighting vectors, and the MAC, for algorithmically implementing the MAC in hardware. The hardware implementation is discussed in greater detail below in connection with a dynamic read module. The input data is shown as a node of unsigned values, e.g., magnitudes, for data points in the node. The input data has a length of N-bits. N may be, for example, 4 bits, 8 bits, 16 bits, etc. If N is 8, for example, then each of the input values is between 0 and 255. The weighting vectors are signed weighting values in 2's complement format. As such, negative numbers will lead with a 1 in the most significant bit (MSB). The length of each of the weighting vectors are K-bits. N may be equal to K or may be a different value. If K is 8 bits, for example, then each of the weighting values may be between −128 and 127. In the notation, for the input values, the i-th input corresponds to the input index of the input data points in the node. Each of the weights will have a corresponding i-th weight index of the weighting vectors. In other words, there is a one-to-one correlation of the i-th input and the i-th weighting vector.

The length of each i-th input may be different than each i-th weighting vector. The input is ordered from least significant bit (LSB) to MSB. For example, the r-th value of the i-th input is equal to I_{i,r}×2^{r}. The weighting vectors are ordered opposite to the input, that is, from MSB to LSB. For example, the j-th value of the i-th weighting vector is equal to W_{i,j}×2^{K-j-1} In the input, the k=0 bit is the least significant bit (LSB) and has the value I_{i,0}×2⁰ for the i-th input.

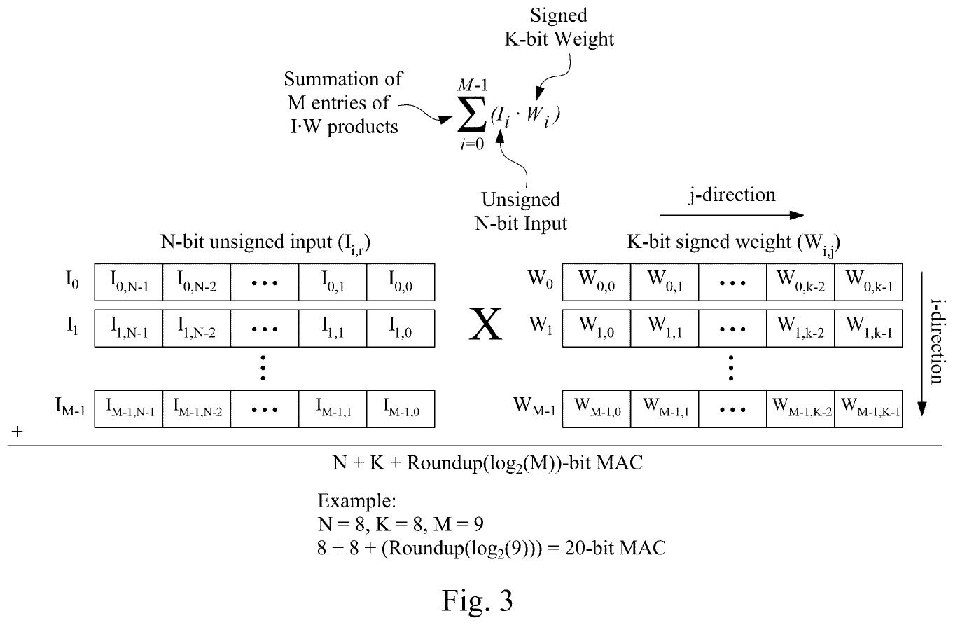

As noted in FIG. 3, the total number of bits resulting from the MAC is equal to N plus K plus the logarithm (base 2) of M, rounded up to the nearest integer. For example, if the number of inputs in the node is 9 (e.g., corresponding to a 9 point convolution) and N and K are each 8, then the number of bits in the output of the MAC is 8+8+Roundup (log₂9)=20. This value can equally be expressed as Roundup (N+K+log₂ M).

Given these relationships, FIG. 4 illustrates a mathematical formula for processing the input values and weighting vectors in a bitwise manner. By bitwise manner, each of the input values is multiplied by each bit of the weighting vectors and summed after each iteration. On the left hand side of the equation is the general formula for the sum product of an i-number of inputs and corresponding i-number of weighting vectors. This summation can be broken down into the right hand side of the equation which includes a first term for handling the sign bits of the weight vectors and a second term for handling the remaining bits.

The first term represents the summed products of the N-bit unsigned inputs and the sign bit of each of the signed K-bit weight vectors. As noted in FIG. 3, the MSB of the weighting vectors holds the sign bit and is notated as the 0th bit of the weight vector, for bit j=0. The first term multiplies the input by the 0th bit of the weighting vector (representing the sign bit) and multiplies that result by the place value of the 0th bit, which is equal to 2^{K-1}. This result is then recorded as a negative value. Essentially, the multiplication between the input and the sign bit establishes the maximal negativity of the weighting vectors. For example, if the weighting vector is 8-bits and is negative, i.e., W_{i,0}=1, the sign bit represents a ‘1’ in the 2⁷ place value. In binary math, this is equivalent to taking the 2 s complement of the input and left shifting it 7 times. This is done iteratively for each of the inputs Ii and the first term represents the summed result of all of these products. When the corresponding weighting vector is not negative, i.e., W_{i,0}=0, then a zero would be added.

The second term includes two options for implementation. In the first option, the second term includes two nested summation operations. The interior summation represents the summed total of each of the remaining j-bits in the weighting vector Wᵢ, multiplied by the input Iᵢ, multiplied by the place value for the corresponding j-th bit in the weighting vector Wᵢ. In other words for a particular input li, the entire input Iᵢ will be multiplied by each j bit individually and its corresponding j place value (2^{K-j-1}) of the j bit of the weight vector and added up. The exterior summation repeats the interior summation for each input Iᵢ and weighting vector Wᵢ and adds all these summations together.

In the second option, the second term includes two nested summation operations, however, they are in reverse order from that used in the first option. The interior summation represents the summed total of each input Iᵢ multiplied by a particular weighting vector bit value for each one of the K weighting vectors. These values are added up. Then each input Iᵢ is multiplied by the next weighting vector bit for each one of the K weighting vectors. In this manner all of the weighting bits are processed for each place value before moving onto the next place value and so forth.

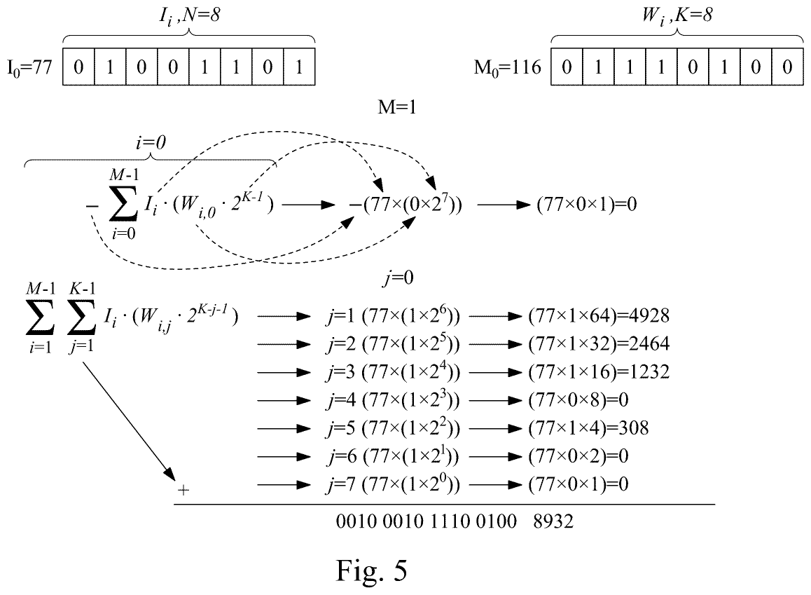

FIG. 5 shows an example implementation of the summation formula illustrated in FIG. 4. An single input I and single weighting vector W are used, where M=1, N=8, and K=8. I₀=77 (0100 1101) and W₀=116 (0111 0100). In the summation

$$- {\sum }_{i = 0}^{M - 1} {I}_{i} \cdot ( {W}_{i , 0} \cdot {2}^{K - 1} ) + {\sum }_{i = 0}^{M - 1} {\sum }_{j = 1}^{K - 1} {I}_{i} \cdot ( {W}_{i , j} \cdot {2}^{K - j - 1} ) ,$$

the first term may be reconciled as −(77·0·2⁷)=0000 0000. The second term may be reconciled as 77·(1·2⁶)+77·(1·2⁵)+77·(1·2⁴)+77·(0·2³)+77·(1·2²)+77·(0·2¹)+77·(0·2⁰)=77·2⁶+77·2⁵+77·2⁴+77·2²=4928 (1 0011 0100 0000)+2464 (1001 10100000)+1232 (100 1101 0000)+308 (1 0011 0100)=8932 (0010 0010 1110 0100). The first term (0) is added to the second term to result in the sum 8932 (0010 0010 1110 0100).

If instead, the weighting vector were negative, i.e., −116 (1000 1100), the result would be as follows: −(77·1·2⁷)=−(0100 1101)·2⁷=1011 0011·2⁷=101 1001 1000 0000. The second term may be reconciled as 77·(0·2⁶)+77·(0·2⁵)+77·(0·2⁴)+77·(1·2³)+77·(1·2²)+77·(0·2¹)+77·(0·2⁰)=77·2³+77·2²⁼⁶¹⁶ (0010 0110 1000)+308 (0001 0011 0100)=924 (0011 1001 1100). The first term is added to the second term to result in the sum −8932 (1101 1101 0001 1100).

As can be seen in this example, when the weighting vector is negative, the bitwise math sets the weighting vector at −128 times the input and then the subsequent bits add back positive portions to the negative number (making it less negative) until the final result is reached. Where the weighting vector is positive, the first term will result in ‘0’ and the second term will be the bitwise summation of the remaining bits of the weighting vector.

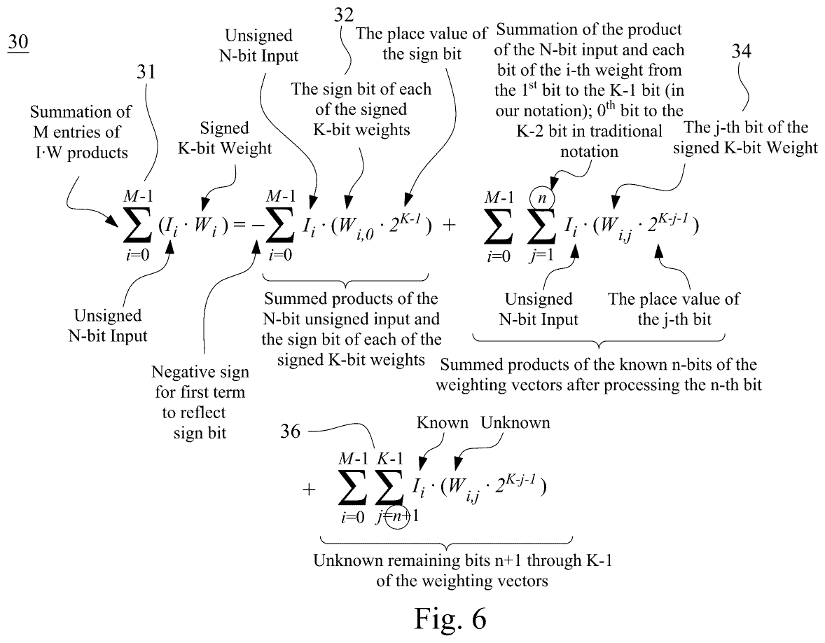

FIG. 6 breaks down the right hand term of FIG. 4 into two pieces to represent the status of computation at a given point, for example, after processing n bits of the weighting vectors W. The first piece

$$( {\sum }_{i = 0}^{M - 1} {\sum }_{j = 1}^{n} {I}_{i} \cdot ( {W}_{i , j} \cdot {2}^{K - j - 1} ) )$$

provides the partial sum for the MAC operation through the n-th bit of the weighting vectors W. The second piece

$$( {\sum }_{i = 0}^{M - 1} {\sum }_{j = n + 1}^{K - 1} {I}_{i} \cdot ( {W}_{i , j} \cdot {2}^{K - j - 1} ) )$$

characterizes the remaining unknown partial sum from the n+1-bit to the K-1-bit of the weighting vectors W. At any given n, the known partial sum will be collected as the accumulated partial sum and the unknown remaining sum is yet to be calculated.

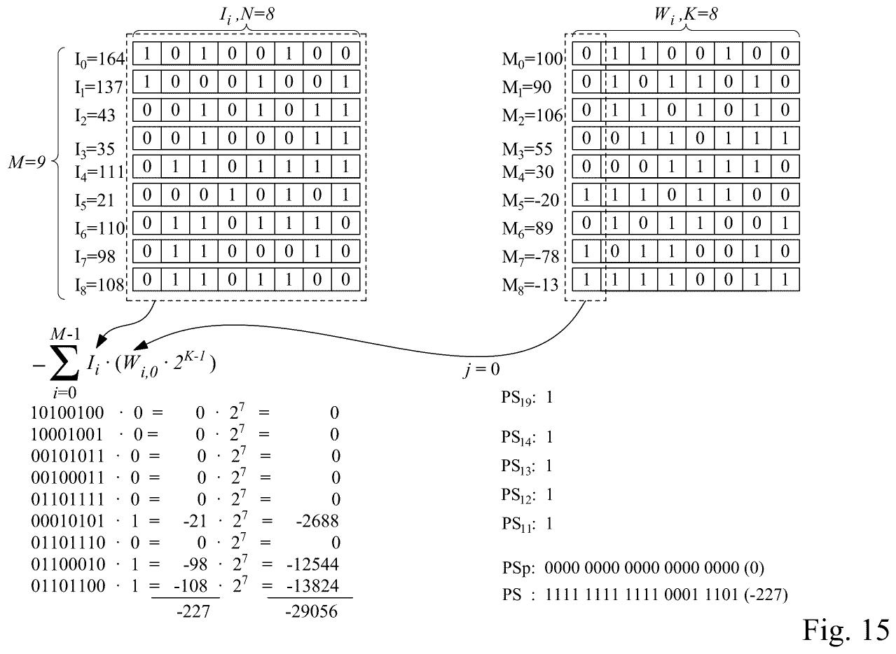

Embodiments evaluate the known partial sum to determine if the remaining calculations may be performed using a reduced read energy to read the weighting bits from memory which are used in the subsequent calculation. Using a reduced read energy increases the likelihood of an incorrect memory read or, as noted below with respect to some embodiments, forces the remaining unread bits to ‘0’. This allowed error effectively results in an estimation of sorts for the unknown remaining sum. This error may be allowable for a couple of reasons. First, because the weighting vectors are processed from the MSB to the LSB, the unknown remaining sum is generally much smaller than the known partial sum and contributes much less to the final MAC value than the earlier evaluated bits represented by the known partial sum. For example, in the example calculation that follows with respect to FIGS. 15-22, the MAC output would be 38,865 if fully calculated. Of this value, the last one bit of the weighting vectors only contributes 253 to the value, the last two bits only contribute 1,317 to the value, the last three bits only contribute 2,641 to the value, last four bits contribute 6,017 to the value, and the last five bits contribute 15,601 to the value. These respectively represent 0.7%, 3.4%, 6.8%, 15.5%, and 40.1% of the value of the MAC output 38,865. While these percentages and values are particular to these inputs and weighting vectors as presented below, they represent (as one would expect) that the contributions of the lesser significant bits of the weighting vectors impact the value of the final MAC less. Second, the output of the MAC is understood to be some representation of the input data (and not the actual data itself) and so some error may be tolerable since the final representation itself is a derived representation of the input data. As such, embodiments provide the ability to test the accumulated product sum to determine if a reduced read energy may be used to read the bits for calculating the unknown remaining sum.

Using a reduced read energy (RRE) signal, embodiments provide a way of reducing the computational energy of the multiply accumulate function by monitoring the partial sum accumulation, and if the partial sum accumulation meets certain conditions, reducing the memory read energy used to read input values from memory for the remaining computations. Reducing the memory read energy will cause a greater risk that an incorrect value will be read, but at a reduced energy cost. As noted above, this effectively results in an estimated or approximated final accumulated value. Since the conditions are monitored such that an exact value is unneeded, then the estimated value is deemed to be sufficient for the purposes of the input processing. When conditions of the partial sum meet the conditions for reducing the read energy, embodiments may implement a dynamic read operation to reduce the read energy consumption by reducing the read voltage, shortening the read latency, or skipping read operations. These embodiments will be described in detail below.

Suppose, for example, that a nominal voltage of 0.2V is the read voltage (or bias voltage) used to read a memory location. When the partial sum meets the conditions as described below, if the read voltage can be reduced to 0.1V, the total energy required to perform the multiply accumulate operation can be significantly reduced. For example, the average read energy can be characterized by the equation:

$${RE}_{AVG} = {P}_{1} \times {E}_{1} + {P}_{2} \times {E}_{2} ,$$

where P₁ is the probability that the read voltage will be the nominal read voltage V₁ (e.g., 0.2V), E₁ is the energy consumption when the read voltage is the nominal read voltage V₁, P₂ is the probability that the read voltage will be a reduced read voltage V₂ (e.g., 0.1V), and E₂ is the energy consumption when the read voltage is the reduced read voltage V₂. As an example of energy consumption, for an MRAM device, E₁ may be about 256 fJ/bit and E₂ may be about 144 fJ/bit. If P₁=P₂=50%, then the average read energy is 0.5×256+0.5×144=200 fJ/bit. The energy savings in such a scenario would be 256−200)/256=22%. Of course, one will understand that these values are merely examples and other values may be used depending on the memory type, read voltages, and energy consumption at that read voltage.

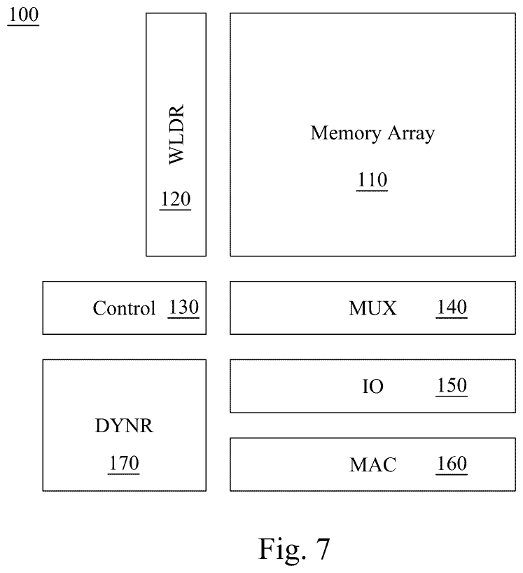

FIG. 7 illustrates a CIM system diagram for providing a MAC operation, in accordance with some embodiments. This system may be referred to as MAC system 100. MAC system 100 includes several blocks. A memory array 110 (or memory 110 or memory device 110) holds input values and weighting vectors. The memory array 110 may be any suitable array of any suitable memory devices. For example, the memory array 110 may include resistive RAM (RRAM), magnetic RAM (MRAM), dynamic RAM (DRAM), synchronous DRAM (SDRAM), phase change RAM (PCRAM), and so forth, or combinations thereof. A word line driver (WLDR) 120 may be used to drive the word lines for accessing bits from the memory array 110. A control block 130 contains an x-decoder for the word lines and a y-decoder for the bit line and sensing lines. It also contains timing control for read and write operations. The multiplexer (MUX) 140 selects the bit line and sense line based on the decoded signal from control. The input/output (IO) block provides sense amplifiers for input/output operations from the memory array 110. The multiply accumulate unit (MAC) block 160 provides the functional units for performing the MAC operation, such as an adder, multiplier, register, etc. The dynamic read (DYNR) block 170 calculates whether an a reduced read energy condition is met and asserts an RRE signal based on whether the reduced read energy condition is met.

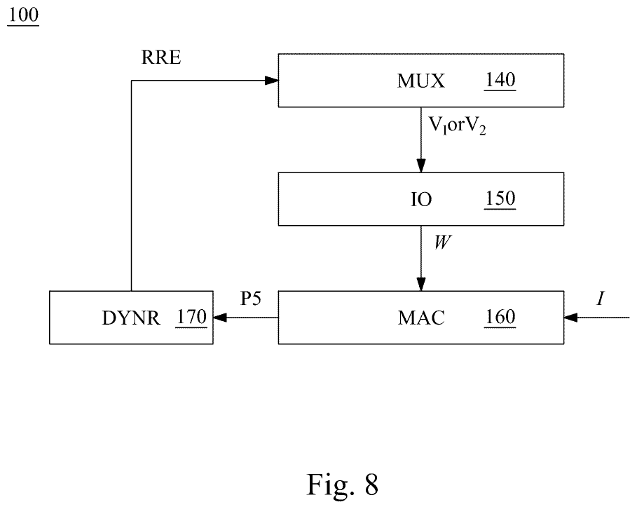

FIG. 8 illustrates a high-level block diagram 100 for a dynamic read operation, in accordance with some embodiments. In the dynamic read operation, some of the system blocks work together to determine whether data provided to the MAC block 160 is read using a reduced read energy or read using a nominal read energy. The dynamic read (DYNR) block 170 provides a reduced read energy (RRE) signal to the multiplexer (MUX) block 140. The initial condition of the input can depend on whether the read configuration is desired to be more energy saving or more reliable. In accordance with some embodiments, depending on the input, the multiplexer block 140 will provide a dynamic read bias voltage V₁ or V₂ used for precharging the bit line sense amplifier inputs of an input/output (IO) block 150. The IO block 150 is used to read weighting vectors W bits from a memory device which are provided to a multiply accumulator compute (MAC) block 160. Inputs I are also provided to the MAC block 160. The input vectors I and weight vectors W have a one-to-one correspondence so that the number M of input vectors is equal to the number M of weight vectors. A partial sum PS (either part of (i.e., selected bits) or the entire partial sum) is provided to the DYNR block 170 which can be used by the DYNR block 170 to test the partial sum for a set of conditions which determines whether the RRE signal is asserted from the DYNR block 170 back to the MUX 140 for subsequent processing. In some embodiments, each of the weight vectors is processed one complete weight vector at a time, and that sum is accumulated as the partial sum PS. In such embodiments, the output of the MAC then is another partial sum that is accumulated in another MAC register. In other embodiments, such as discussed in detail in the following, each of the weight vectors is partially processed so that all the j-bits of each of the weighting vectors is processed for each of the inputs, then the j+1 bits of each of the weighting vectors is processed, and so forth.

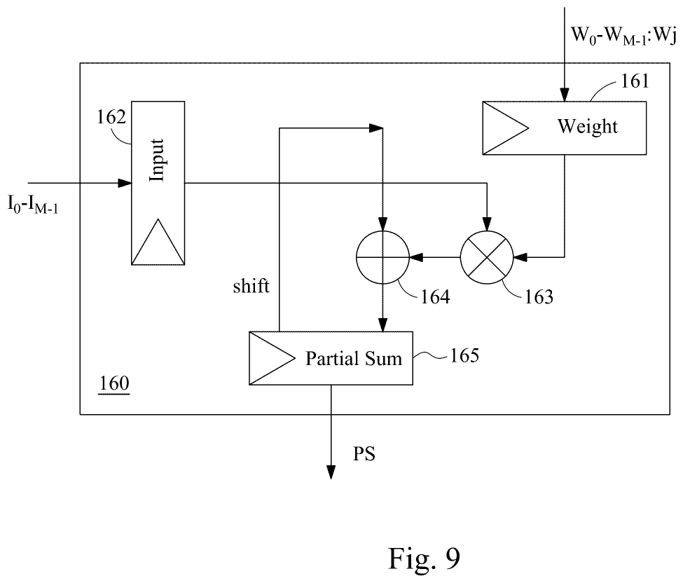

FIG. 9 illustrates an example implementation of the MAC block 160. The Wⱼ bits of each of the W₀-W_{M-1} are provided to a weight register 161. The inputs I₀-I_{M-1} are provided into a set of input registers 162. Each of these inputs is multiplied by the Wⱼ bit of each of the weighting vectors at the multiply block 163. The result is provided to an adder block 164, which adds the multiplication result to the previously stored partial sum, after it has been shifted. The result is then stored back into the partial sum register 165. The partial sum PS may be provided to the DYNR block 170.

It should be understood that the sub-blocks of the MAC block 160 may be configured in various ways. In some embodiments, the input register 162 holds one input vector at a time, and in other embodiments, the input register 162 may hold all of the input vectors for the data node. In some embodiments, the weight register 161 holds one signed weight vector or corresponding bits from each of the weight vectors, and in other embodiments, the weight register 161 holds one bit from the weight vector at a time. The multiply block 163 may utilize a shift register to multiply the input vector by the weight vector in a bit-wise manner, from the most significant bit of the weight vector to the least significant bit. Then, following the multiplication of the input vector by the weight vector, the result may be provided to the adder block 164 and then to the partial sum block 165.

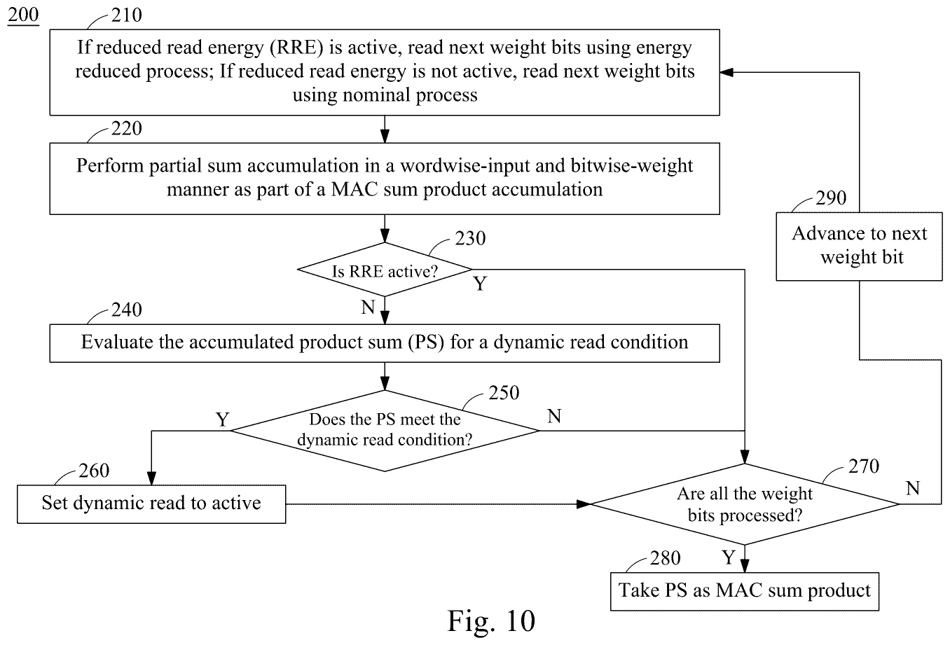

FIG. 10 illustrates a flow diagram providing a process flow 200 for performing a MAC operation, in accordance with some embodiments. At 210, if the reduced read energy (RRE) signal is active, the next weight bits are read using an energy reduced process; if the RRE signal is not active, then the next weight bits are read using a nominal process. As noted above, the energy reduced process may include using a reduced bias voltage, a shortened timing, and/or skipped reading (e.g., by reducing the bias voltage to 0, causing the remaining bits to be read as ‘0’). At 220, a partial sum accumulation process is performed in a wordwise-input and bitwise weight manner as part of a MAC sum product accumulation. At 230, the RRE is evaluated for being active. If it is not active, then the partial sum (PS) is evaluated at 240 for a dynamic read condition. If the RRE is active, then in some embodiments, the RRE signal stays active until if the RRE is active it does not go back to inactive unless it is reset. As such, if the RRE is active, then the flow can jump to 270 to evaluate if all the weight bits are processed. Again at 250, if the PS meets the conditions for enabling the dynamic read operation, then the RRE will be set to active, otherwise the flow can go to 270 and evaluate if all the weight bits are processed. If all the weight bits are processed, then the PS is taken as the MAC output at 280. If all the weight bits are not yet processed, then at 290 the system advances to the next weight bit of the weighting vectors.

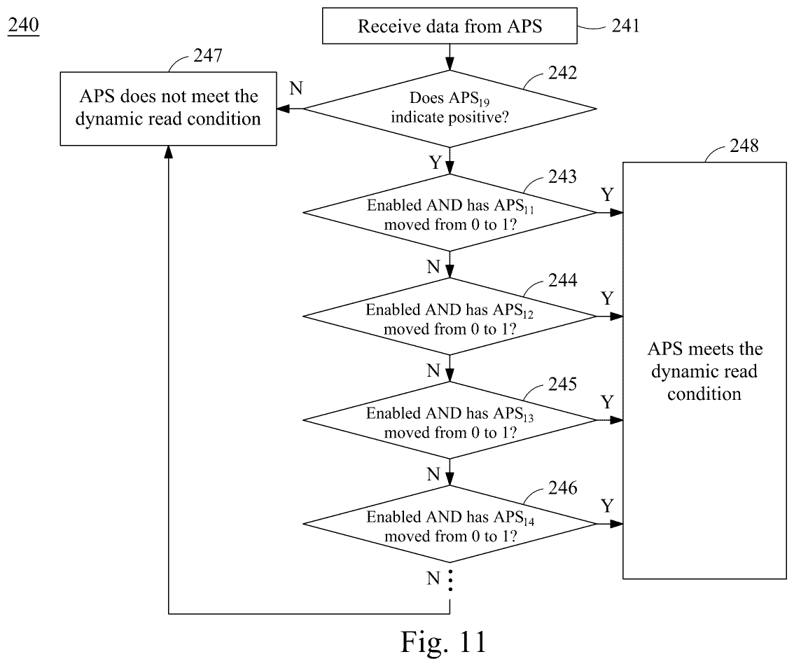

FIG. 11 illustrates a flow diagram providing process flow 240 (see FIG. 10) for evaluating if the PS meets a dynamic read condition. At 241, data is received from the PS. The data received may be the entire APS or may be select bits from the PS. At 242, the 19^{th} bit (or sign bit) of the PS (PS₁₉) is checked to determine if whether the value of the PS is positive or negative. If the PS is negative, then the process can jump to 247, thereby determining that the PS does not meet the dynamic read condition. If the PS is positive, then it can be further evaluated. If the PS is not 20 bits long, then the bit selected may be whatever the sign bit is of the PS. For example, if the PS is 24 bits long, then the sign bit would be PS₂₃. Process elements 243, 244, 245, and 246 each test a particular bit of the PS to determine if it has moved from a 0 to a 1. In particular, element 243 tests PS₁₁, element 244 tests PS₁₂, element 245 tests PS₁₃, and element 246 tests PS₁₄. These bit values are merely examples. More or fewer than four of the PS bits may be made available to test. Further, the bit indexes tested may be different than bits 11, 12, 13, and 14. Selection of which bits are tested will be discussed in further detail below, after exploring an example of this process.

In some embodiments, such as illustrated in FIG. 11, one or more of the illustrated bits 11, 12, 13, and/or 14 may be enabled to be tested. In some embodiments, the testing element may be enabled or disabled as desired for each bit. Testing the earlier bits would result in the PS meeting the dynamic read condition at 248 at an earlier stage in the process. Once an earlier bit is tested, e.g., bit 11 is tested and meets the condition, then a later bit need not be tested, as such, the process may move immediately to the flow element 248, that the PS meets the dynamic read condition.

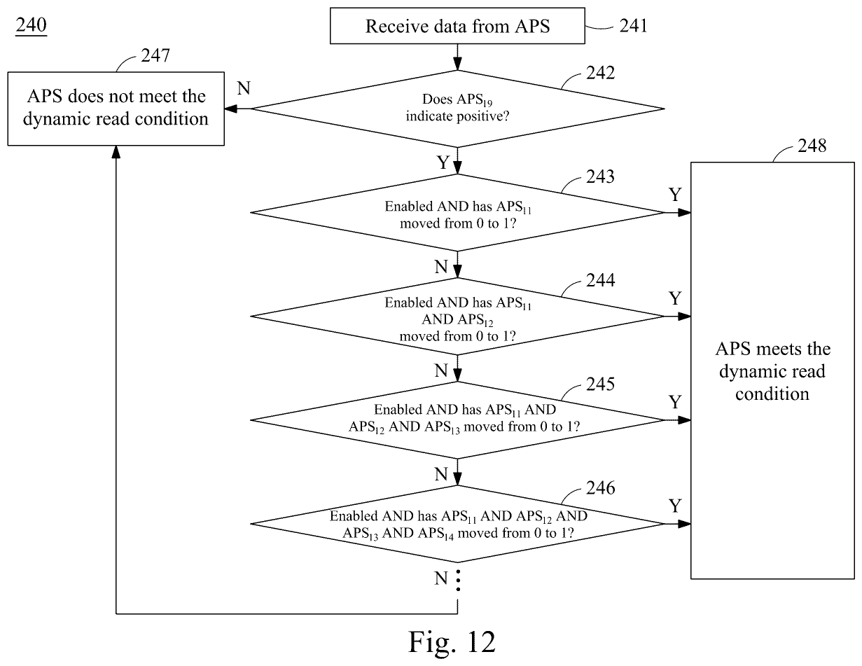

In FIG. 12, in other embodiments, a logical combination of bits may be used. The logical combination illustrated is only an example, and any logical combination may be utilized as desired. Like elements are labeled with like references. At element 244, however, the PS₁₁ bit and PS₁₂ bit are both checked to determine if both have moved from 0 to 1. At element 245, the PS₁₁ bit, PS₁₂ bit, and PS₁₃ bit are all checked to determine if all have moved from 0 to 1. At element 246, the PS₁₁ bit, PS₁₂ bit, PS₁₃ bit, and PS₁₄ bit are all checked to determine if all have moved from 0 to 1. When one of these conditions is met, then the flow moves to element 248 and it is determined that the PS meets the dynamic read condition.

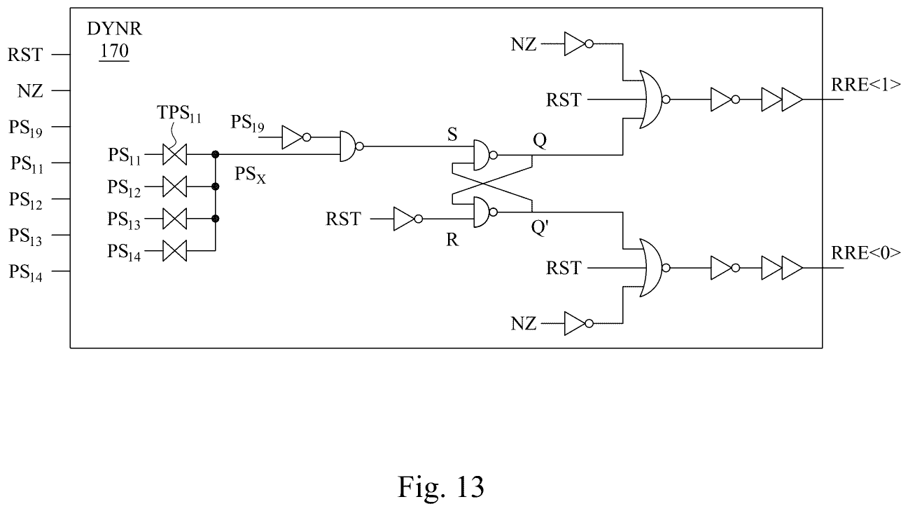

FIG. 13 illustrates an example implementation of the DYNR block 170 for evaluating and determining whether the RRE signal is asserted or not. The DYNR block 170 takes inputs which include a reset input RST which, when asserted signifies that the MAC process is reset. The RST signal may be asserted, for example, by the Control block 130 after the MAC process is completed. When the RST signal is one, then the MAC process should reset. When the RST signal is zero, then the MAC process may continue. The DYNR block 170 also takes an input NZ which signifies that the inputs are not zero. If NZ is 0, then the computation should not be performed since the output will always be zero, since the inputs are multiplied by the weighting vectors. If NZ is 1, then the inputs are not zero and the MAC process may continue. The PS₁₉ bit assumes a 20-bit partial sum 165 (see FIG. 9). If the partial sum 165 has another bit length b, then the sign bit would be PS_{b-1} and that would be the bit checked instead of the PS₁₉ bit. The PS₁₉ bit is checked to determine if the partial sum 165 is negative-that is ‘1’. If the partial sum 165 is negative, then the RRE signal will not be asserted. If the partial sum 165 is positive, then the RRE signal may be asserted, depending on the value of other bit(s) of the partial sum 165.

FIG. 13 also illustrates that the PS₁₁, PS₁₂, PS₁₃, and PS₁₄ bits may be received by the DYNR block 170, in accordance with some embodiments. Each of these bits may also have a corresponding enable bit signal coming from the Control block 130 which enables the transmission gate for the respective bit signal. For example, the transmission gate TPS₁₁ may have an enable input, which enables the transmission gate to transmit from the input PS₁₁ to the output PSₓ. The enable input for TPS₁₁ may also originate as an input, but is not illustrated for the sake of simplicity. This enable input may come from the Control block 130 or can be generated internally. The enable input allows the signals for PS₁₁, PS₁₂, PS₁₃, and PS₁₄ to transmit selectively to the output signal PSₓ. For example, the DYNR block 170 may test the lowest bit PS₁₁ for j=0, the next one (PS₁₂) for j=1, the next one (PS₁₃) for j=2, and the next one (PS₁₄) for j≥3. Or in another example, the DYNR block 170 may test the lowest bit PS₁₁ for j=≤1, the next one (PS₁₂) for j=2, the next one (PS₁₃) for j=3, and the next one (PS₁₄) for j≥4. Other configurations are possible. For example, in some embodiments, the selected bit may be based on the total sum value of the inputs. The maximum total sum is (N⁸−1)×M, where N is the bitlength of the inputs and M is the number of inputs. For N=8 and M=9, the maximum input sum IS is 2295. In an embodiment, for example, if the total sum input IS is in the bottom quartile (1≤IS≤573), then the lowest bit PS₁₁ may be enabled for selection into the output signal PSₓ. If the total input sum IS is in the second quartile (574≤IS≤1147), then the next bit PS₁₂ may be enabled. If the total input sum IS is in the third quartile (1148≤IS≤1721), then the next bit PS₁₃ may be enabled. If the total input sum IS is in the fourth quartile (1722≤IS≤2295), then the next bit PS₁₄ may be enabled.

It should be understood, that the bits described above (PS₁₁, PS₁₂, PS₁₃, and PS₁₄) for testing are based on an assumed 20-bit partial sum 165. If the number of inputs M is larger or smaller or the bitlength N of the inputs is larger or smaller, then it may be appropriate to test other bits of the partial sum 165. For example, the index of the lowest bit tested may be equal to the number of bits N+the Roundup (log₂ M)−1. The next three bits may then index off of that one. In the described example, this would result in 8+4−1=11, and the next three indexes 12, 13, and 14. Because the partial sum PS 165 is built iteratively, the PS stores values which are iteratively left-shifted as each weight bit is processed for the weighting vectors. This means that the bits being tested should be based on the bit lengths of the inputs, the bit lengths of the weighting vectors, and the number of inputs in the input node. Where the partial sum is also sized based on these factors, the test bits may be approximated based on the length of the partial sum. In some embodiments, the tested bits may be in the upper half of the partial sum, although other bits may also be used.

Still referring to FIG. 13, the output PSₓ is provided to a NAND gate along with the inverted PS₁₉ signal. If both of these are 1, then the output of the NAND gate will be 0, and otherwise 1. This output feeds into the S side of an SR latch and the R side of the SR latch receives the inverted RST signal. The outputs Q and Q′ of the SR latch are provided to respective NOR gates along with the RST signal and NZ signal. The outputs of the NOR gates respectively provide the RRE<1> or RRE<0> signals. That is, the inverted outputs of the NOR gates signal the value of RRE<1> and RRE<0>. When the RST signal is 0 and NZ signal is 1, then only one of these outputs can be ‘1’ at a time since they are based on the opposite signals Q and Q′ from the SR latch. When it is described below that RRE<0>=0, the normative condition for the Vread bias is used. When RRE<1>=0, then the risky read for the Vread bias is used. If both RRE<0>=0 and RRE<1>=0, this is considered a high priority read, and the higher Vread will be used. Unless otherwise noted, a reference to RRE<1> indicates that RRE<1>=0 and that RRE<0>=1, enabling a reduced bias voltage, i.e., risky read. Similarly, a reference to RRE<0> indicates that RRE<0>=0 and RRE<1>=1, enabling a normative bias voltage, i.e., safe read. One will understand that the logic provided in FIG. 13 is only an example, and other implementations are possible.

A truth table is provided below which illustrates the relationship between the signals RST, NZ, PS₁₉, PSₓ, S, R, Q, Q′, RRE<1>, and RRE<0>. The letter X indicates that the output is not signal dependent and the letters NC indicate that there is no change.

TABLE 1

| | RST | NZ | PS₁₉ | PS_{X} | S | R | Q | Q′ | RRE<1> | RRE<0> |
|---|---|---|---|---|---|---|---|---|---|---|
| 1 | 1 | 0 | 0 | 0 | 1 | 0 | 1 | 0 | 0 | 0 |
| 2 | X | 0 | X | X | X | X | X | X | 0 | 0 |
| 3 | 0 | 1 | 1 | X | 1 | 1 | NC | NC | 1 | 0 |
| 4 | 0 | 1 | 0 | 0 | 1 | 1 | NC | NC | 1 | 0 |
| 5 | 0 | 1 | 0 | 1 | 0 | 1 | 0 | 1 | 0 | 1 |

At row 1 of TABLE 1, the RST signal is activated, resetting the SR latch; RRE<0> and RRE<1> both equal 0, and so the higher voltage will be used in Vread biasing. At row 2 of TABLE 1, the input is 0, causing the NZ to be equal to 0; RRE<0> and RRE<1> both equal 0, and so the higher voltage will be used in Vread biasing. At row 3 of TABLE 1, the partial sum PS is negative; RRE<0> is used, and so the safe read will be used in Vread biasing. At row 4 of TABLE 1, the partial sum PS is positive, but the selected partial sum bit PSₓ is 0; RRE<0> is used, and so the safe read will be used in Vread biasing. At row 5 of TABLE 1, the partial sum PS is positive, and the selected partial sum bit PSₓ is 1; RRE<1> is used, and so the risky read will be used in Vread biasing.

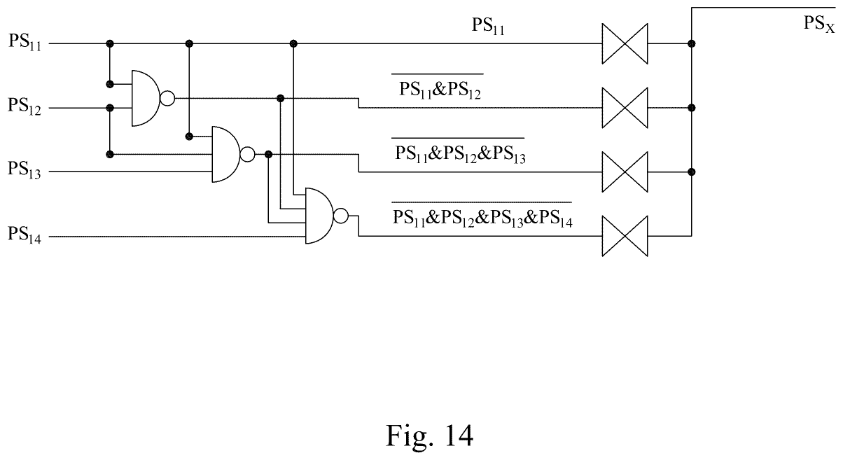

FIG. 14 illustrates an example set of logic conditions which may be enabled rather than a one-for-one input of the select bits of the partial sum 165. This logic implements the flow from elements 243, 244, 245, and 246 of FIG. 12. Other logic conditions may be used and the illustrated logic conditions are only to be taken as an example of using logic combinations to determine the PSₓ signal.

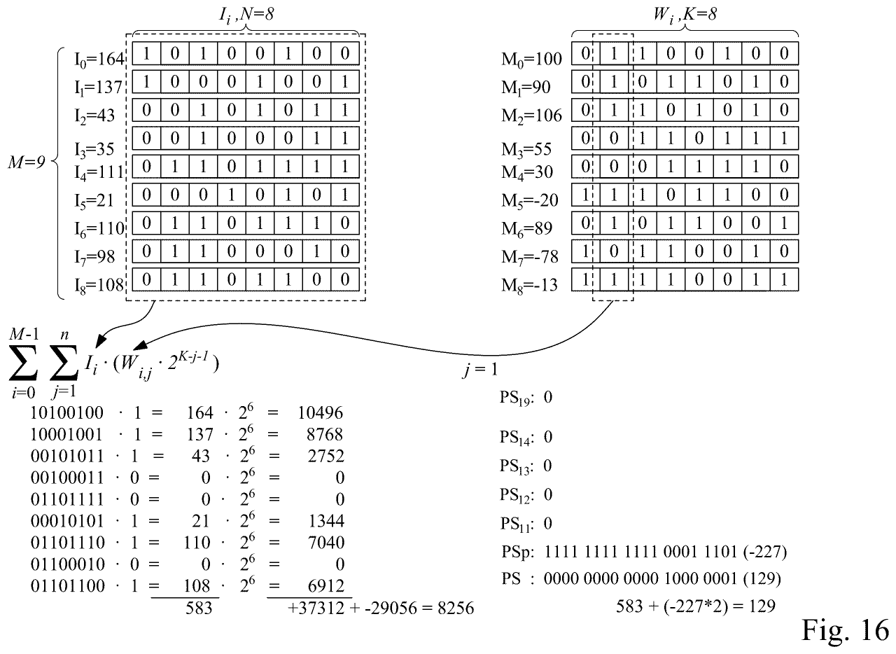

FIGS. 15 through 22 illustrate a sample calculation and demonstration of the operation of the DYNR block 170. At the top of these Figures is a set of M=9 inputs I having a length of N=8 and a set of M weighting vectors W having a length K=8. At the bottom of each of these Figures in the first column is the input values listed again, multiplied in the second column by the respective bit weight for the weighting vectors for W_{i,j} being processed. The immediate sum is provided in the third column of values. The fourth column of values demonstrates the bit value multiplier, or in other words, 2^{K-1-j}, for the j-th bit of the weighting vectors W being processed. The fifth column is the product of the i-th input multiplied by the j-th weight bit of the i-th weighting vector multiplied by the place value multiplier. The bottom of the third columns and fifth columns show summations for the immediate sum and the value sum, respectively. The immediate sum is accumulated with the partial sum. The partial sum register 165 is illustrated as showing the current partial sum PS value. The previous partial sum PSp is also provided which is carried over from the previous value, showing the partial sum PS just before it is shifted. The PS₁₉, PS₁₄, PS₁₃, PS₁₂, and PS₁₁ are separately called out and provided from the partial sum PS. FIGS. 16 through 22 also provide, at the bottom of each Figure, the calculations of the current immediate sum with the previous immediate sum (shifted) and the calculations of the previous value sum and the current value sum are provided. These aspects will be further explained in greater detail below.

In FIG. 15, the first term 32 of the calculation 30 is provided. This term calculates the sign bit for the inputs I multiplied by the weighting vectors W. If any of the weighting vectors are negative, then the result will be negative, otherwise the result will be zero. Since the weighting vectors W are in signed 2's complement format, the MSB of the weighting vectors which are negative will be a ‘1’ and the MSB of the weighting vectors which are positive will be a ‘0’. Multiplying the inputs I by the negative weighting vectors W therefore results in the most negative that the final value can be. The value sum after calculating the sign bit will be as if the value of the weighting vectors was −128 (1000 0000). Any other bit in the weighting vector which is a ‘1’ and not a ‘0’ will result eventually in the final product sum becoming less negative. As illustrated in FIG. 15, the input I₀ is multiplied by the bit W_{0,0}, the input I₁ is multiplied by the bit W_{1,0}, the input I₂ is multiplied by the bit W_{2,0}, and so forth until the input I₈ is multiplied by the Weight W_{8,0}. The only weighting vector bits which are ‘1’ correspond to W_{5,0}, W_{7,0}, and W_{8,0}. The products of the respective inputs and these weights are −21, −98, and −108, respectively. These are summed to provide the partial sum of −227, which is stored as the partial sum (1111 1111 1111 0001 1101) in the partial sum PS register 165. The bit value for this sum is also provided (to be consistent with paragraph 55, 56), which is −29056. The PS₁₉, PS₁₄, PS₁₃, PS₁₂, and PS₁₁ are each equal to 1. Because the PS₁₉ bit indicates a negative number, then the RRE<0> signal remains 0, indicating that a reduced read energy should not be used.

In FIGS. 16 through 22, the second term 34 for the calculation 30 has started being processed, e.g., for values of the weighting vectors where j≥1. In FIG. 16, j=1 and corresponding bits for the weighting vectors W are multiplied by respective inputs. As illustrated in FIG. 16, the input I₀ is multiplied by the bit W_{0,1}, the input I₁ is multiplied by the bit W_{1,1}, the input I₂ is multiplied by the bit W_{2,1}, and so forth until the input I₈ is multiplied by the Weight W_{8,1}. The only weighting vector bits which are ‘1’ correspond to W_{0,1}, W_{1,1}, W_{2,1}, W_{5,1}, W_{6,1}, and W_{8,1}. The products of the respective inputs and these weights are 164, 137, 43, 21, 110, and 108, respectively. These are summed to provide the intermediate sum of 583. The previous partial sum PSp −227 is left shifted to become −454 and added to the intermediate sum 583 to provide the new partial sum PS 129, which is stored as the partial sum (0000 0000 0000 1000 0001) in the partial sum PS register 165. The bit value for this sum is also provided (to be consistent with paragraph 55, 56), which is 8256 (e.g., if the bit-place values were multiplied as well). The PS₁₉ bit is now equal to 0 indicated that the PS is positive. The PS₁₄, PS₁₃, PS₁₂, and PS₁₁ bits are now, however, also equal to 0. Although the PS₁₉ bit indicates a positive number, then the RRE<0> signal remains 0 because none of the PS₁₄, PS₁₃, PS₁₂, and PS₁₁ bits will trigger PSₓ to 1. Thus, a reduced read energy should not be used for the next reading.

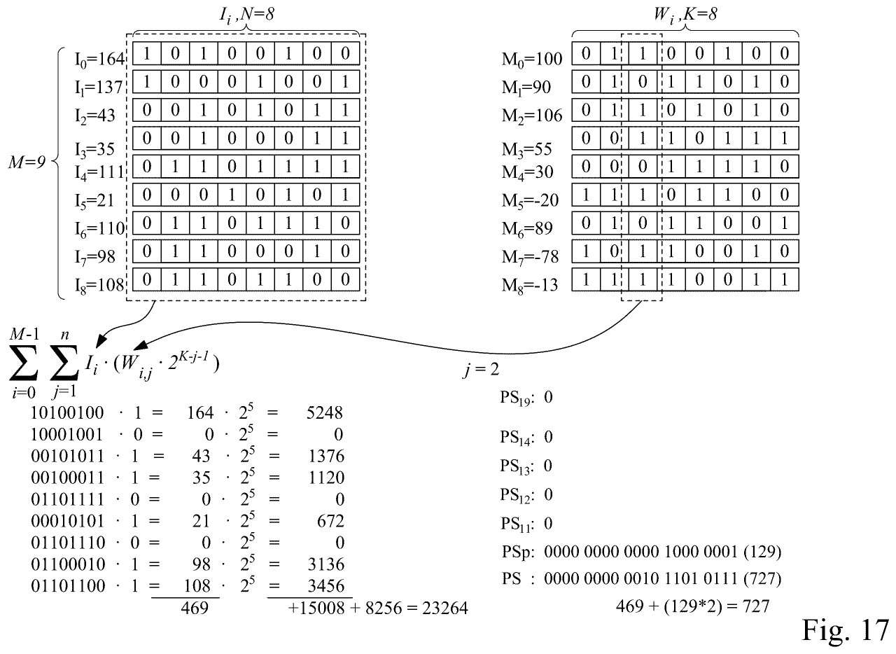

In FIG. 17, j=2 and corresponding bits for the weighting vectors W are multiplied by respective inputs. As illustrated in FIG. 17, the input I₀ is multiplied by the bit W_{0,2}, the input I₁ is multiplied by the bit W_{1,2}, the input I₂ is multiplied by the bit W_{2,2}, and so forth until the input I₈ is multiplied by the Weight W_{8,2}. The only weighting vector bits which are ‘1’ correspond to W_{0,2}, W_{2,2}, W_{3,2}, W_{5,2}, W7,2, and W_{8,2}. The products of the respective inputs and these weights are 164, 43, 35, 21, 98, and 108, respectively. These are summed to provide the intermediate sum of 469. The previous partial sum PSp 129 is left shifted to become 258 and added to the intermediate sum 469 to provide the new partial sum PS 727, which is stored as the partial sum (0000 0000 0010 1101 0111) in the partial sum PS register 165. The bit value for this sum is also provided, which is 8256+15008=23264 (e.g., if the bit-place values were multiplied as well and added to a previous partial sum). The PS₁₉ bit is equal to 0 indicated that the PS is positive. The PS₁₄, PS₁₃, PS₁₂, and PS₁₁ bits are, however, still equal to 0. Although the PS₁₉ bit indicates a positive number, the RRE<0> signal remains 0 because none of the PS₁₄, PS₁₃, PS₁₂, and PS₁₁ bits will trigger PSₓ to 1. Thus, a reduced read energy should not be used for the next reading.

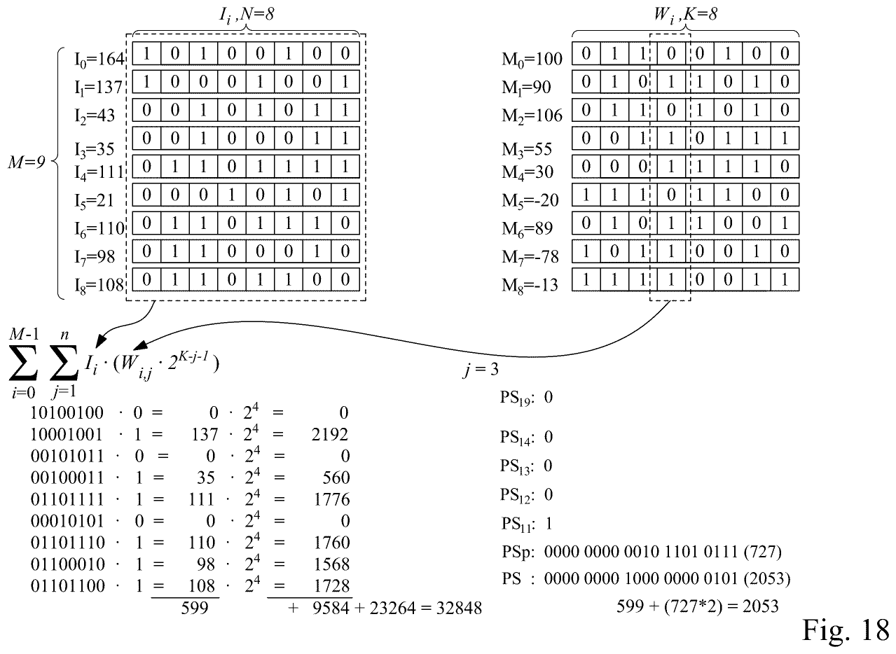

In FIG. 18, j=3 and corresponding bits for the weighting vectors W are multiplied by respective inputs. As illustrated in FIG. 18, the input I₀ is multiplied by the bit W_{0,3}, the input I₁ is multiplied by the bit W_{1,3}, the input I₂ is multiplied by the bit W_{2,3}, and so forth until the input I₈ is multiplied by the Weight W_{8,3}. The only weighting vector bits which are ‘1’ correspond to W_{1,3}, W_{3,3}, W_{4,3}, W_{6,3}, W_{7,3}, and W_{8,3}. The products of the respective inputs and these weights are 137, 35, 111, 110, 98, and 108, respectively. These are summed to provide the intermediate sum of 599. The previous partial sum PSp 727 is left shifted to become 1454 and added to the intermediate sum 599 to provide the new partial sum PS 2053, which is stored as the partial sum (0000 0000 1000 000 0101) in the partial sum PS register 165. The bit value for this sum is also provided, which is 23264+9584=32848 (e.g., if the bit-place values were multiplied as well and added to a previous partial sum). The PS₁₉ bit is equal to 0 indicated that the PS is positive. The PS₁₄, PS₁₃, and PS₁₂ bits are still equal to 0, however the PS₁₁ bit has triggered to 1. If the transmission gate for the PS₁₁ bit is enabled, the PS₁₁ bit will transmit to the PSₓ bit and the RRE<1> signal will be provided (RRE<1>=0), resulting in a reduced read energy for the next reading. For the sake of this illustration, one can assume that the transmission gate TPS₁₁ is not enabled, and so PSₓ remains 0. Thus, a reduced read energy is not used for the next reading.

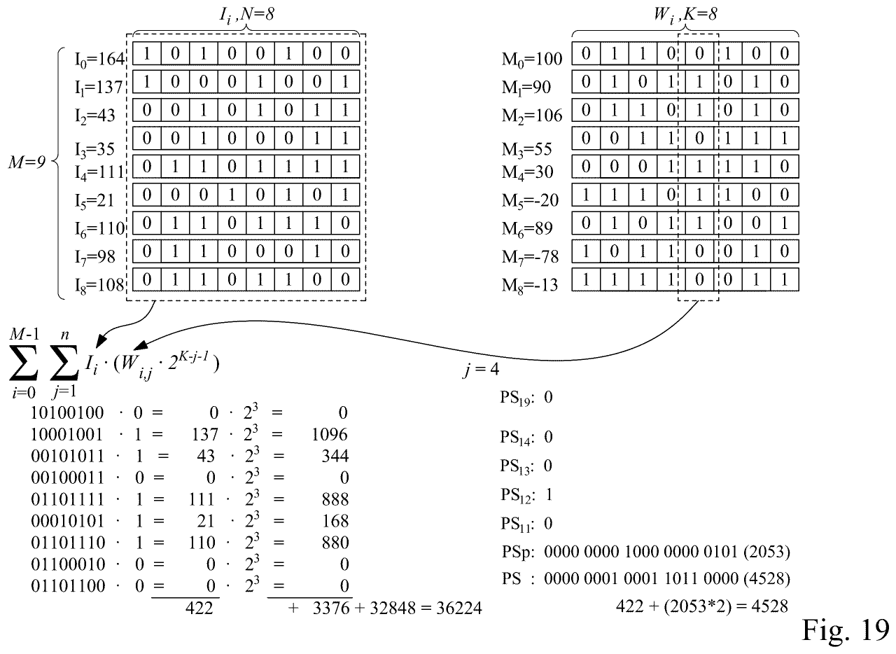

In FIG. 19, j=4 and corresponding bits for the weighting vectors W are multiplied by respective inputs. As illustrated in FIG. 19, the input I₀ is multiplied by the bit W_{0,4}, the input I₁ is multiplied by the bit W_{1,4}, the input I₂ is multiplied by the bit W_{2,4}, and so forth until the input I₈ is multiplied by the Weight W_{8,4}. The only weighting vector bits which are ‘1’ correspond to W_{1,4}, W_{2,4}, W_{4,4}, W_{5,4}, and W_{6,4}. The products of the respective inputs and these weights are 137, 43, 111, 21, and 110,respectively. These are summed to provide the intermediate sum of 422. The previous partial sum PSp 2053 is left shifted to become 4106 and added to the intermediate sum 422 to provide the new partial sum PS 4528, which is stored as the partial sum (0000 0001 0001 1011 0000) in the partial sum PS register 165. The bit value for this sum is also provided, which is 32848+3376=36224 (e.g., if the bit-place values were multiplied as well and added to a previous partial sum). The PS₁₉ bit is equal to 0 indicated that the PS is positive. The PS₁₄, PS₁₃, and (now) PS₁₁ bits are equal to 0, however the PS₁₂ bit has triggered to 1. If the transmission gate for the PS₁₂ bit is enabled, the PS₁₂ bit will transmit to the PSₓ bit and the RRE<1> signal will be provided, resulting in a reduced read energy for the next reading. For the sake of this illustration, one can assume that the transmission gate for the PS₁₂ bit is not enabled, and so PSₓ remains 0. Thus, a reduced read energy is not used for the next reading.

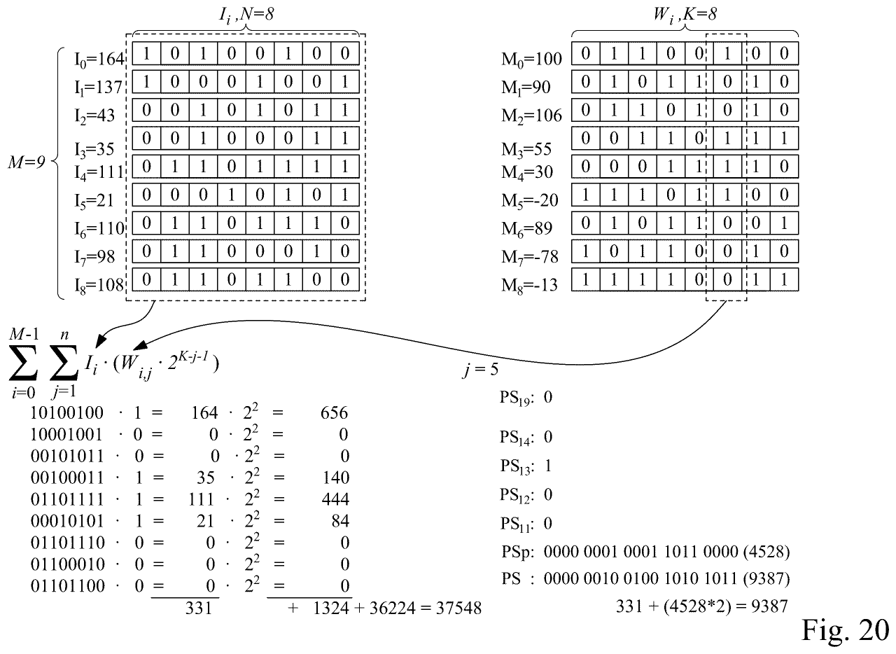

In FIG. 20, j=5 and corresponding bits for the weighting vectors W are multiplied by respective inputs. As illustrated in FIG. 20, the input I₀ is multiplied by the bit W_{0,5}, the input I₁ is multiplied by the bit W_{1,5}, the input I₂ is multiplied by the bit W_{2,5}, and so forth until the input I₈ is multiplied by the Weight W_{8,5}. The only weighting vector bits which are ‘1’ correspond to W_{0,5}, W_{3,5}, W_{4,5}, and W_{6,5}. The products of the respective inputs and these weights are 164, 35, 111, and 21, respectively. These are summed to provide the intermediate sum of 331. The previous partial sum PSp 4528 is left shifted to become 9056 and added to the intermediate sum 331 to provide the new partial sum PS 9387, which is stored as the partial sum (0000 0010 0100 1010 1011) in the partial sum PS register 165. The bit value for this sum is also provided, which is 36224+1324=37548 (e.g., if the bit-place values were multiplied as well and added to a previous partial sum). The PS₁₉ bit is equal to 0 indicated that the PS is positive. The PS₁₄ and (now) PS₁₂ and PS₁₁ bits are equal to 0, however the PS₁₃ bit has triggered to 1. If the transmission gate for the PS₁₃ bit is enabled, the PS₁₃ bit will transmit to the PSₓ bit and the RRE<1> signal will be provided, resulting in a reduced read energy for the next reading. For the sake of this illustration, one can assume that the transmission gate for the PS₁₃ bit is not enabled, and so PSₓ remains 0. Thus, a reduced read energy is not used for the next reading.

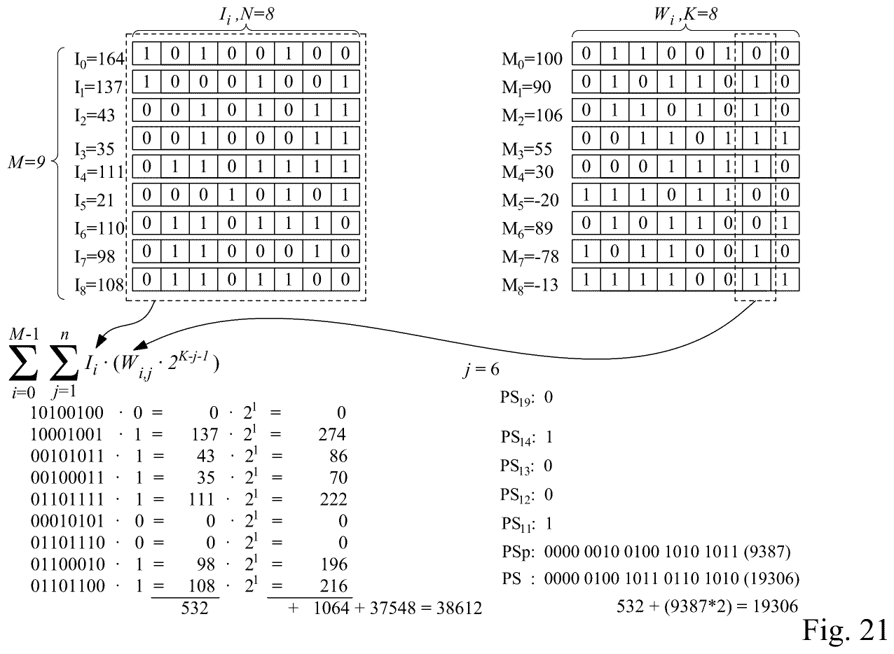

In FIG. 21, j=6 and corresponding bits for the weighting vectors W are multiplied by respective inputs. As illustrated in FIG. 21, the input I₀ is multiplied by the bit W_{0,6}, the input I₁ is multiplied by the bit W_{1,6}, the input I₂ is multiplied by the bit W_{2,6}, and so forth until the input I₈ is multiplied by the Weight W_{8,6}. The only weighting vector bits which are ‘1’ correspond to W_{1,6}, W_{2,6}, W_{3,6}, W_{4,6}, W_{7,6}, and W_{8,6}. The products of the respective inputs and these weights are 137, 43, 35, 111, 98, and 108, respectively. These are summed to provide the intermediate sum of 532. The previous partial sum PSp 9387 is left shifted to become 18774 and added to the intermediate sum 532 to provide the new partial sum PS 19306, which is stored as the partial sum (0000 0100 100 1011 1010) in the partial sum PS register 165. The bit value for this sum is also provided, which is 37548+532=38612 (e.g., if the bit-place values were multiplied as well and added to a previous partial sum). The PS₁₉ bit is equal to 0 indicated that the PS is positive. The PS₁₄ has now triggered to 1. If the transmission gate for the PS₁₄ bit is enabled, the PS₁₄ bit will transmit to the PSₓ bit and the RRE<1> signal will be provided, resulting in a reduced read energy for the next reading. For the sake of this illustration, one can assume that the transmission gate for the PS₁₄ bit is enabled, and so PSₓ now becomes 1. Thus, a reduced read energy RRE<1> is used for the next reading.

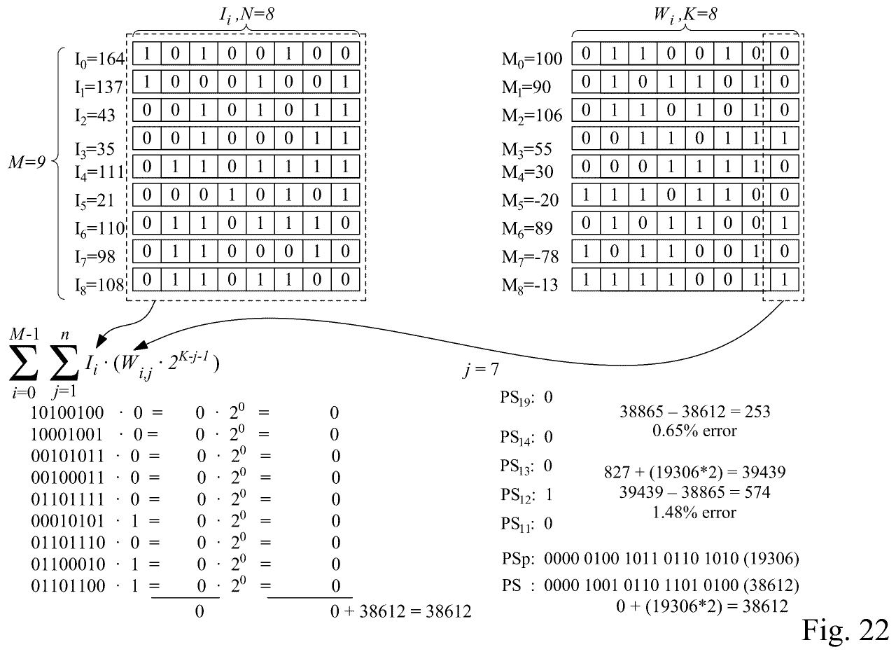

In FIG. 22, j=7 and corresponding bits for the weighting vectors W are multiplied by respective inputs. However, because of the RRE<1> signal is enabled, a reduced read energy is used to read the weighting vector W bit values for W_{i,7}, resulting in a reduction in total power consumption. FIG. 22 illustrates the case where all of the weighting vectors for the W_{i,7} values are read to equal 0. This may occur in some embodiments deliberately to enable a skip read condition. In such embodiments, the memory location is not actually read and is presumed to be a 0. In FIG. 22, the difference between the calculated PS and the actual MAC value if the MAC process had been carried out to completion is 253, resulting in a 0.65% error. FIG. 22 also provides the values if the max value (all W_{i,7}=1) had been observed, resulting in an intermediate value of 827 and a difference from the actual MAC value of 574, resulting in a 1.48% error. This could be considered a worst case scenario for this particular set of calculations, since it provides the greatest deviation possible from the actual MAC value.

From the preceding calculation it can be observed that later calculations contribute much less as a percentage to the PS than earlier calculations. As the earlier calculations are left shifted, they take on more significance with each iteration. Thus, one can see that although reducing the read energy presents a higher risk that an incorrect value will be read, the tradeoff may be worth it in reduced savings. In actuality the read risk introduced is much less than the worst case scenarios discussed with respect to FIG. 22, as will be discussed in greater detail below.

In the above example, the RRE<1> signal was triggered by observing the PS₁₄ bit. At that point, the calculated partial sum PS contributed 99.35% of the total MAC value. If the PS₁₃ bit had triggered the RRE<1> signal, then the calculated partial sum at that point would have represented 96.61% of the total MAC value. If the PS₁₂ bit had triggered the RRE<1> signal, then the calculated partial sum at that point would have represented 93.2% of the total MAC value. If the PS₁₁ bit had triggered the RRE<1> signal, then the calculated partial sum at that point would have represented 84.52% of the total MAC value.

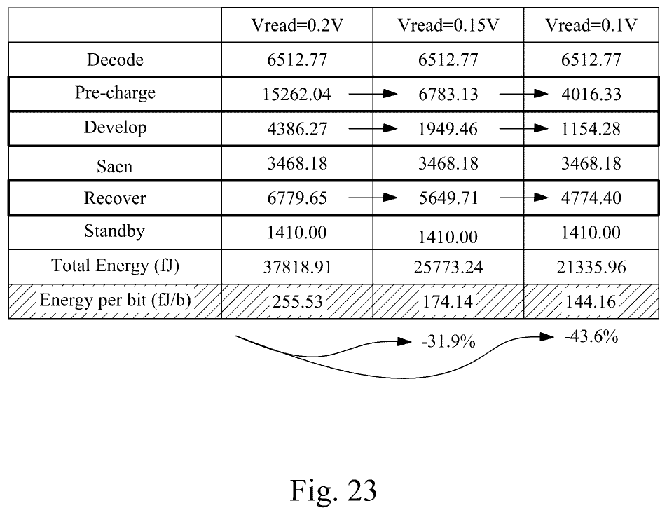

FIG. 23 provides a chart demonstrating the reduced read energy which may be obtained when the RRE<1>=0. Vread=0.2V may be considered a nominal read voltage in some embodiments, i.e., used when RRE<0>=0. Energy savings may be obtained when dropping Vread to 0.15V, 0.1V, or lower. The energy used for the pre-charge, develop, and recover processes of reading the memory signal may be reduced. Dropping the pre-charge voltage from 0.2V to 0.15V, for example, lowers the energy usage from about 15262 fJ to about 6783 fJ. Dropping the pre-charge voltage from 0.2V to 0.1V, in another example, lowers the energy usage from about 15262 fJ to about 4016 fJ. Energy savings are also observed with the develop and recover processes. After totaling the sum of the energy usage, the total energy per bit of 255.5 fJ may be reduced to 174.1 fJ at 0.15V and 144.2 fJ at 0.1V. This represents an energy savings of 31.9% and 43.6%, respectively. It should be understood that these values are merely examples and the energy consumption may vary based on the memory type and process conditions, such as operating temperature and so forth. In some embodiments, altering the pre-charge, develop, and recover voltage by 25% can result in an energy savings between about 25% and about 35% and altering the pre-charge, develop, and recover voltage by 50% can result in an energy savings between about 38% and 48%. The chart in FIG. 23 also shows that some energy consumption does not change based on the Vread voltage value, thus, a baseline energy consumption occurs regardless of the value of Vread.

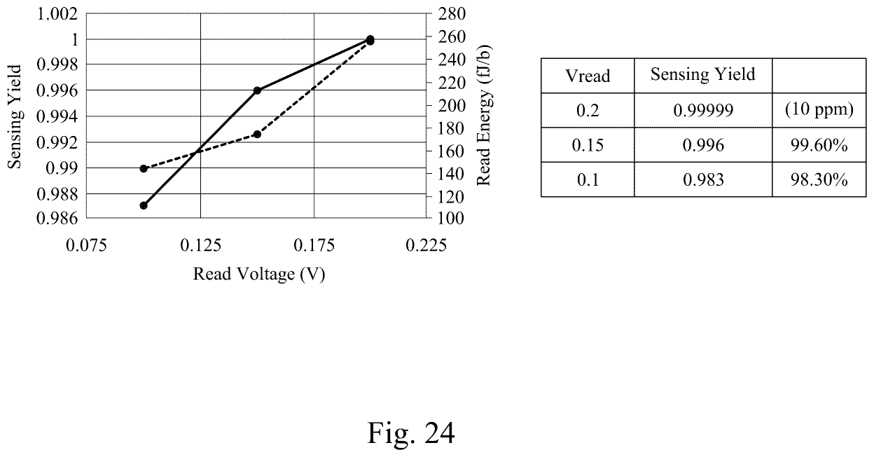

FIG. 24 illustrates the relationship between read voltage and the sensing yield, in accordance with some embodiments. When the Vread is 0.2V the sensing yield is essentially error free. When the Vread is 0.15V, the sensing yield drops to 99.6%±0.3% and when the Vread is 0.1V, the sensing yield drops to about 98.3%±0.4%. Essentially, for example, this means that when the Vread is 99.6%, about every 4 of 1000 bit readings is incorrect, and when the Vread is 0.1V, about every 17 of 1000 bit readings is incorrect. Further, as can be observed in FIG. 24, as the Vread drops, the read energy also drops, however, the drop in energy is not proportionate to the drop in Vread. Similarly, as the Vread is increased the sensing yield is increased, however, the sensing yield is not proportionate to the Vread. Therefore, the Vread can be chosen to balance the energy savings with the sensing yield (reliability), depending on the designer's error tolerance and energy savings goals.

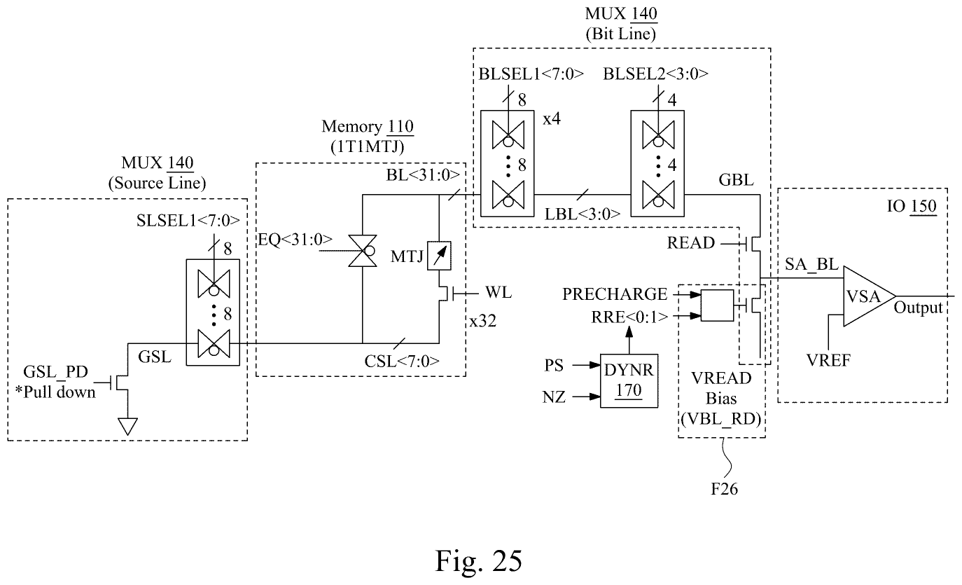

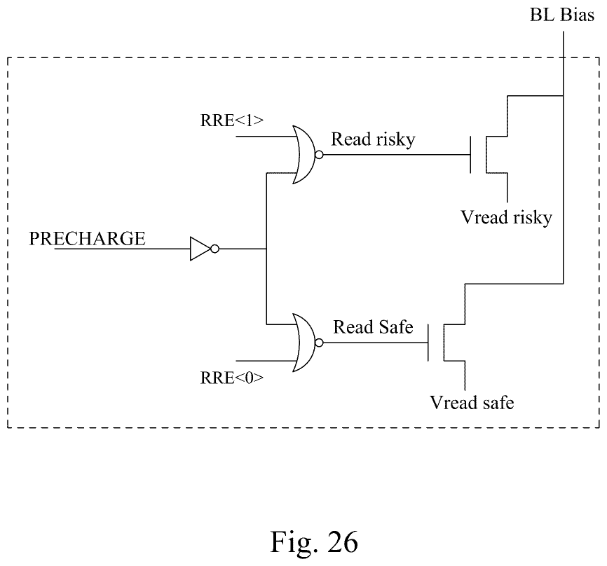

FIG. 25 illustrates a simplified schematic illustrating the read path of one IO associated with an array dimension of 1 word line WL, 32 bit lines BL, and 8 common source lines. This schematic should be understood as being only an example, and other implementations may be used. The source line MUX 140 includes a global source line pull down GSL_PD transistor attached to the global source line GSL. The global source line GSL goes into a set of source line transmission gates controlled by a set of first source line select SLSEL1 lines. The output of the MUX 140 is used to control common source lines CSL of the memory 110. In this example, the memory 110 is illustrated as a 1 transistor 1 magnetic tunnel junction 1T1MTJ MRAM device, however, other memory devices may be used as discussed above. The wordline WL signal is an input to the memory 110 from the word line driver WLDR 120. The bit line MUX 140 provides a set of transmission gate inputs from first bit line select BLSEL1 signals and from second bit line select BLSEL2 signals which enable the BL of the memory 110 to flow first to the local bit line LBL using the BLSEL1 signals and then to the global bit line GBL using the BLSEL2 signals to select which bit lines BLs are selected for output to the IO 150. The DYNR block 170 provides an RRE<0:1> signal output to connect a selected Vread bias voltage (see FIG. 26). The READ gate control signal enables the global bit line GBL to flow to the sensing amplifier for the bit line SA_BL. A voltage type sensing amplifier VSA is illustrated which utilizes a reference voltage to compare the BL value with and amplifies the global bit line GBL to provide the output. The PRECHARGE gate control signal enables the Vread bias voltage VBL_RD to precharge the voltage sensing amplifier of the IO 150. An expanded view of the boxed area F26 is provided in FIG. 26.

FIG. 26 illustrates an expanded view of the dashed box F26 of FIG. 25. In FIG. 26, the outputs of the DYNR block 170 are coupled to the MUX 140 to provide the biasing for the bit line BL, in accordance with some embodiments. The PRECHARGE signal is a gate control signal to enable the Vread bias voltage. The DYNR block 170, however, provides the RRE<1> and RRE<0> signals to provide a different Vread bias voltage depending on whether the RRE<1> signal is enabled (i.e., equals 1) or disabled (i.e., equals 0). Thus, the logic of FIG. 26 provides a way to interface the PRECHARGE signal with the RRE<1> and RRE<0> signals to control which Vread bias voltage is used. Notably, alternative embodiments may be used. For example, alternative logic may be used. in some embodiments the RRE signal is a single line that has the value 1 or 0 depending on if the reduced read energy should be used. In FIG. 26, when the PRECHARGE signal is a 0 then neither gate will turn on. When the PRECHARGE signal is a 1, then if RRE<0>=0, the safe read will be used and the bit line bias BL Bias will be biased with the Vread safe bias voltage. If the RRE<1>=0, the risky read will be used and the BL Bias will be biased with the Vread safe bias voltage. If for some reason (e.g., after resetting the MAC), both the RRE<0> and RRE<1>=0, then the higher voltage would be used, i.e., Vread safe.

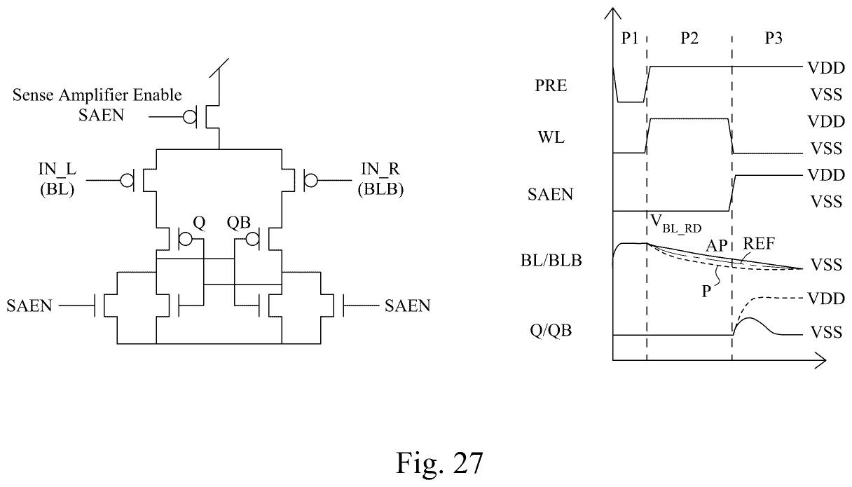

FIG. 27 illustrates a view of a timing diagram and sense amplifier, in accordance with some embodiments. In some embodiments, the RRE<1> signal can enable the control block 130 to alter the timing of the read operation to shorten the time taken to perform the reading, resulting in a reduced energy usage. In some embodiments, the length of time that the pre-charge voltage is provided may be reduced, resulting in a reduction in total power provided during the pre-charge time. In other embodiments, the length of time used to discharge the bit line voltage may be reduced, resulting in a reduction in total power discharged during the read time. The risk of shortening the latency timing of the read operation is that some values may not read correctly due to the shortened timing. Before sensing by the VSA the voltages associated with logic ‘0’ and logic ‘1’ of the data (for example, on the bit line BL) are precharged and discharged to be compared with a reference voltage. For example, for an MRAM memory device 110, the anti-parallel high resistance state may stand for a ‘0’ and the parallel low resistance state may stand for a logic ‘1’. A similar setup can be made for other memory types. The anti-parallel and parallel states are compared with the reference voltage to obtain the stored data in the memory device 110. Shortening the read latency can reduce the energy used. In FIG. 27 the illustrated timing diagram includes three time periods—period 1 P1 which is used for preparation and bit line pre-charge to Vread, period 2 P2 which is used for discharging the bit line voltage through the memory structure of the memory device 110, and period 3 P3 which is used for enabling the sense amplifier and outputting Q/QB of the sense amplifier. In some embodiments, the period P1 may be shortened by cutting the time used for pre-charging the bit line short. The risk is that the bit line may not be charged enough to compare the value to the reference voltage to receive a reliable reading. In some embodiments, the period P2 may be shortened by cutting the time used for discharging the bit line short. The risk is that the bit line may not be discharged enough to compare the value to the reference voltage to receive a reliable reading.

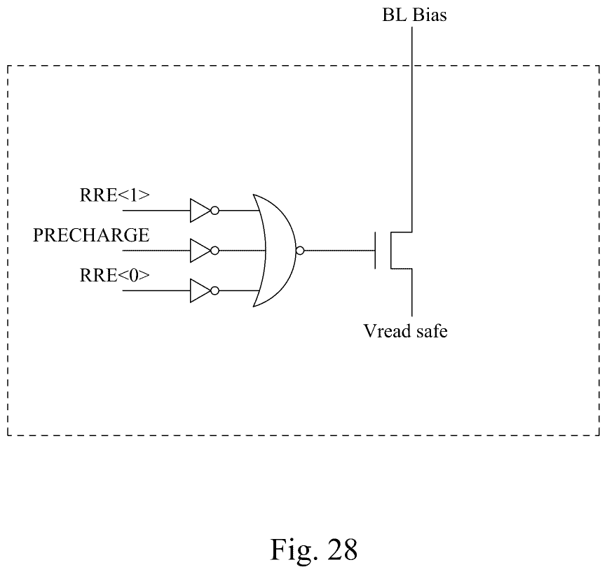

FIG. 28 illustrates a view of a logic circuit diagram which provides no precharging if RRE<1>=0. In some embodiments, when the RRE<1> is met, then the remaining weighting vector W bits may be read as 0s. This may be done by forcing precharging to be bypassed. When precharging is bypassed, all (or most) of the remaining weighting vector bits will be read as 0s. An example of this is provided in FIG. 22, where despite additional weight bits being available, the remainder of the bits are processed as being 0s. It should be noted that it may be possible to read out a 1 even without applying a precharge voltage in some instances, although no energy is provided by a precharging voltage. When precharging is enabled and RRE<1>=1, then the precharging would read as normal. Setting the precharging to be disabled may also be accomplished by setting the Vread risky voltage to ground in FIG. 26. It should be understood that other logic may be used to accomplish bypassing the precharging. The logic provided here should not be taken as being exclusionary of other logic.

Embodiments achieve advantages. A dynamic read voltage condition may be set by monitoring the partial sum in a compute-in-memory MAC operation. When certain conditions of the partial sum are met, the memory read energy may be reduced for the rest of the MAC operation. The energy reduction may occur by providing a lower (riskier) precharge bias voltage for a voltage sense amplifier, a shortened latency timing period in performing the sense operation, or by skipping reading the remaining weighting vectors, assuming the rest to be 0s. Combinations of these operations may also be used. For example, the shortened latency may be combined with any of the other strategies. The skipping may also be combined with the lower precharge bias voltage by implementing skipping after monitoring conditions on different bits of the partial sum PS than those used for the risky voltage biasing. For example, the PS₁₁ bit may trigger a risky read condition for Vread. The PS₁₂ bit may trigger lower latency in addition to the risky voltage biasing. And the PS₁₃ or PS₁₄ bit may trigger the remaining bits to be skipped.

One embodiment is a method including determining whether a partial-sum of a compute-in-memory (CIM) operation is positive to obtain a first result. The method also includes determining whether a chosen bit of the partial-sum transmits from 0 to 1 to obtain a second result. The method also includes in response to both the first result and the second result are true, adjusting a read configuration of a read operation of a memory cell of the CIM. In an embodiment, the read configuration is adjusted to reduce a timing latency to wait to read the memory cell. In an embodiment, the read configuration is adjusted to reduce a bias voltage used to read the memory cell. In an embodiment, the read configuration is adjusted to remove a bias voltage used to read the memory cell. In an embodiment, the chosen bit is located in an upper half of the partial-sum.

Another embodiment is a method including reading a first set of bits from a set of weighting vectors from memory utilizing a first read energy. The method also includes multiplying a set of inputs by the first set of bits to obtain a first product. The method also includes adding the first product to an accumulated product sum. The method also includes when the accumulated product sum is positive and a bit-condition of accumulated product sum changes from a 0 to a 1, asserting a reduced read energy signal. The method also includes reading a second set of bits from the set of weighting vectors from memory utilizing a second read energy less than the first read energy. In an embodiment, the method may include: prior to adding the first product to the accumulated product sum, bit shifting the accumulated product sum. In an embodiment, reading the second set of bits utilizes a shorter timing period than a timing period used to read the first set of bits. In an embodiment, reading the second set of bits utilizes a second precharge voltage for a read amplifier which is less than a first precharge voltage used to read the first set of bits. In an embodiment, reading the second set of bits is performed without providing a positive precharge voltage for a read amplifier. In an embodiment, the bit-condition corresponds to a chosen bit of the accumulated product sum having a first index, a second index, a third index, or a fourth index, where the first index is equal to a bit-length of a first input of the set of inputs plus a logarithm base2 of a number of inputs in the set of inputs rounded up to the next integer, where the second index equals the first index plus one, where the third index equals the first index plus two, and where the fourth index equals the first index plus three. In an embodiment, the bit-condition corresponds to a logical combination of two or more chosen bits of the accumulated product sum. In an embodiment, reading the second set of bits from the weighting vectors determines a value of one or more of the second set of bits incorrectly.

Another embodiment is a device including a computer readable memory, the memory storing a set of inputs and a corresponding set of weighting vectors. The device also includes a multiply accumulate device including an adder, multiplier, and partial sum (PS) register, the PS register configured to store accumulated results from iterative product sum operations of the set of inputs and the corresponding set of weighting vectors. The device also includes a multiplexer configured to provide a bias voltage to a sense amplifier for reading the weighting vectors. The device also includes a dynamic read logic configured to evaluate the PS, determine whether a reduced read energy (RRE) signal should be asserted, and assert the RRE signal, the RRE signal provided to the multiplexer. In an embodiment, the device may include: a control block, where the RRE signal is further provided to the control block, the control block providing memory access timing, the control block configured to reduce a read latency for reading the memory when the RRE signal is asserted. In an embodiment, the dynamic read logic is configured to evaluate the PS by examining a sign bit of the PS and a selected bit of the PS. In an embodiment, the selected bit corresponds to a bit index of the PS, the bit index plus one, the bit index plus two, or the bit index plus three, the bit index equal to a bit-length of a first input of the set of inputs plus a rounded up logarithm base2 of a number of inputs of the set of inputs minus one. In an embodiment, the multiplexer is configured to select the bias voltage based on the RRE signal, where when the RRE signal is asserted, the multiplexer is configured to provide a smaller bias voltage than when the RRE signal is not asserted. In an embodiment, when the RRE signal is asserted, the multiplexer is configured to provide a bias voltage which causes the sense amplifier to output a 0. In an embodiment, the dynamic read logic is configured to evaluate the PS by examining a sign bit of the PS and a logical combination of two or more selected bits of the PS.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
determining whether a partial-sum of a compute-in-memory (CIM) operation is positive to obtain a first result;
determining a chosen bit of the partial-sum transmits from 0 to 1 to obtain a second result; and
in response to both the first result and the second result are true, adjusting a read configuration of a read operation of a memory cell of the CIM, wherein the read configuration is adjusted to reduce a timing latency to wait to read the memory cell, and wherein the read configuration is adjusted to reduce a bias voltage used to read the memory cell.
